(19) United States
(12) Patent Application Publication
(10) Pub. No.: US 2012/0311431 A1
(43) Pub. Date: Dec. 6, 2012

(54) SYSTEM AND METHOD FOR AUTOMATICALLY GENERATING A SINGLE PROPERTY WEBSITE

(75) Inventors: Douglas Breaker, Wilmette, IL (US); Eric Sanders, Chicago, IL (US); Jennifer Domonkos, Chicago, IL (US); Jason Aniceto, Chicago, IL (US)

(73) Assignee: HomeFinder.com, LLC, Chicago, IL (US)

(21) Appl. No.: 13/485,395

(22) Filed: May 31, 2012

Related U.S. Application Data
(60) Provisional application No. 61/491,715, filed on May 31, 2011.

(51) Int. Cl. G06F 17/00

(52) U.S. Cl. 715/234

(57) ABSTRACT

A computer-implemented method, a computer system, or a tangible computer-readable medium storing a set of instructions for execution on a processor may operate to automatically generate and update a single property website by aggregating MLS and other real estate listing data corresponding to a property listed within the MLS. The single property website may then be used to publicize the property to attract other brokers and buyers to the property while being linked to a plurality of data sources to provide dynamic and real-time information to a buyer or other brokers for a property.

### CROSS REFERENCE TO RELATED APPLICATIONS

This application claims the benefit of U.S. Provisional Patent Application No. 61/491,715 that was filed on May 31, 2011 the disclosure of which is hereby incorporated herein by reference in its entirety for all purposes.

### FIELD OF TECHNOLOGY

The present disclosure relates generally to automatically generating a website and more specifically to a system and a method configured to automatically generate content from a real-estate property listing database and multiple other data sources corresponding to the listing and automatically create a website for the particular listing using the generated content.

### BACKGROUND

The background description provided herein is for the purpose of generally presenting the context of the disclosure. Work of the presently named inventors, to the extent it is described in this background section, as well as aspects of the description that may not otherwise qualify as prior art at the time of tiling, are neither expressly nor impliedly admitted as prior art against the present disclosure.

A Multiple Listing Service or System (MLS) is a collection of data that allows brokers, generally, and real estate brokers in particular, to facilitate transactions. The most visible use of an MLS is to disseminate real estate listing information among brokers, clients, and the public. The MLS represents sellers under a listing contract to share information about their property with other brokers who represent buyers or who cooperate with a seller's broker to find a buyer for the seller's property. Generally, the data for each MLS property listing is managed and owned by the broker that is in a contractual relationship (e.g., a listing agreement) with the seller of the property.

An MLS organizes and lists real estate listing data among a plurality of member brokers. Each MLS is generally organized by geographic region as buyers are most likely to focus on a geographic area from which to purchase real estate. Each MLS is generally privately managed and rules for membership, access, and information sharing are not uniform among various systems. A broker's membership in an MLS is generally considered essential and most MLS systems restrict membership and access to licensed real estate brokers and agents. While websites may allow public access to some MLS data, open access to an entire MLS is not conducive to brokerage transactions which require adherence to strict contractual obligations to ensure a profit for the broker.

In a typical real estate transaction, a broker lists a seller's property in an MLS and performs other acts to advertise the property to other brokers and potential buyers. While an MLS is generally recognized as the central repository for real estate listing information among real estate brokers, the information is limited to text-based data in a database format that is not conducive to information sharing among the general public. Websites offer a much more convenient, familiar, and dynamic delivery platform for the public versus an MLS listing. A broker may manually create a single property website that presents MLS data and other data from a variety sources. However, manually aggregating relevant listing and sales data into a single property website can be difficult and time consuming.

### SUMMARY

A computer-implemented method, a computer system, or a tangible computer-readable medium storing a set of instructions for execution on a processor may operate to automatically generate and update a single property website by aggregating MLS and other real estate listing data corresponding to a property listed within the MLS. The single property website may then be used to publicize the property to attract other brokers and buyers to the property while being linked to a plurality of data sources to provide dynamic and real-time information to a buyer or other brokers for a property.

In one embodiment, a system may aggregate a plurality of electronic data feeds including information related to one or more listings for a piece of real estate. The computer system may then extract data for the piece of real estate from at least one of the data feeds. Then, the computer system may arrange the extracted data into a single property website for the piece of real estate. The computer system may also extract second data from the electronic data feeds for the piece of real estate, compare the extracted first data and the extracted second data, and update the single property website based on the comparison. In some embodiments, the system may extract the second data after the first data.

In a further embodiment, a computer system for generating a single property website via a network connection may include a memory for storing instructions and a processor for executing the stored instructions. Executing the stored instructions may cause the computer system to aggregate a plurality of electronic data feeds including information related to one or more listings for a piece of real estate. The instructions may also cause the computer system to extract first data for the piece of real estate from at least one of the electronic data feeds and arrange the extracted data into a single property website for the piece of real estate. After extracting the first data, the computer system may extract second data from the electronic data feeds. The system may compare first data and the second data, and the single property website may be updated based on the comparison.

In a still further embodiment, a tangible computer-readable medium may store computer executable instructions that, when executed, cause a computer system to aggregate a plurality of electronic data feeds. The data feeds may include information related to one or more listings for a piece of real estate. The computer system may then extract data for the piece of real estate from at least one of the data feeds. Then, the computer system may arrange the extracted data into a single property website for the piece of real estate. The computer system may also extract second data from the electronic data feeds for the piece of real estate, compare the extracted first data and the extracted second data, and update the single property website based on the comparison. In some embodiments, the system may extract the second data after the first data.

The features and advantages described in this summary and the following detailed description are not all-inclusive. Many additional features and advantages will be apparent to one of ordinary skill in the art in view of the drawings, specification, and claims hereof. Additionally, other embodiments may omit one or more (or all) of the features and advantages described in this summary.

### BRIEF DESCRIPTION OF THE DRAWINGS

FIG. 1 is a high-level block diagram of a system for automatically generating a single property website from a plurality of data sources;

FIGS. 2a and 2b are exemplary block diagrams of a method for automatically generating a single property website;

FIGS. 3a-3f are examples of a user interface and web pages to automatically generate and promote a single property website; and

FIG. 4 is high-level block diagram of a computing environment that implements a system for automatically generating a single property website from a plurality of data sources.

The figures depict a preferred embodiment of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

Generally speaking, a single property website generator system and method may aggregate feeds from a plurality of data sources that are related to a property listing. The property listing 104 may correspond to an MLS listing, but may also correspond to any data resource for a property that is for sale. For example, in addition to an MLS listing, the property listing 104 may include a classified ad, a listing on an independent website (e.g., ForSaleByOwner.com®, Byowner.com®, fizber.com®, etc.), or other sources. The system may then use the feeds to generate and maintain a single property website to advertise the property.

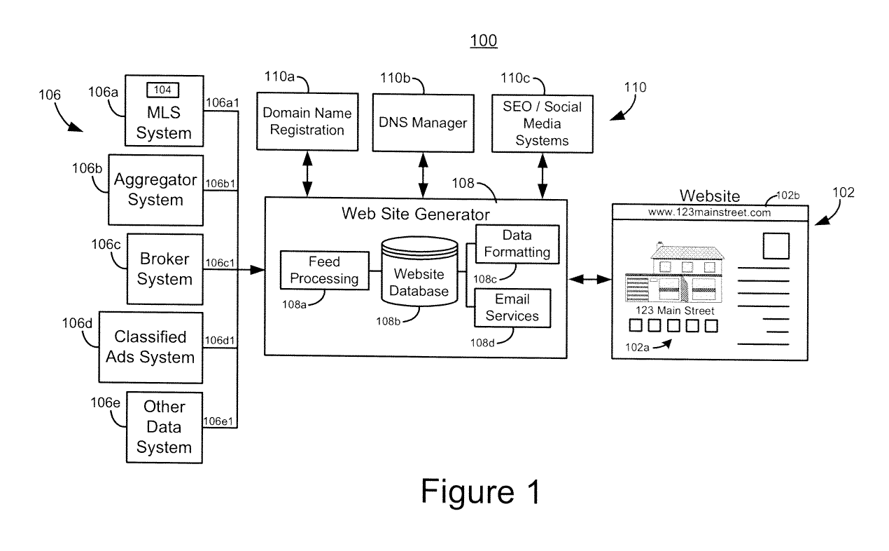

FIG. 1 is a high-level block diagram that illustrates a system 100 for generating and maintaining a single property website 102 corresponding to a property listing 104. The system 100 may include a plurality of data source systems 106 including a Multiple Listing System (MLS) 106a, a data aggregator system 106b, a broker information system 106c, a classified ads system 106d, or other data system 106e. The other data systems 106e may include a for sale by owner database wherein a property owner may list a property for sale using a website rather than using a real estate agent or broker. An additional data system 106e may include a mapping website (e.g., Google®, Bing®, MapQuest®, etc.). Some embodiments may include an additional data system 106e which includes information about average property values in the area, average weather in the area, the local school districts, demographic information about the area, and other information. Generally speaking, each data source system 106 permits the website generator module 108 to access and use data from the data source systems 106 to generate and maintain a database storing content for a single property website 102. Each of the data systems 106 may send data feeds 106a1, 106b1, 106c1, 106d1, and 106e1 (e.g., text or XML files, etc.) that provide content for a website generator module 108 to create and update the single property website 102. Each feed 106a1 , 106b1, 106c1, 106d1, and 106e1 may provide content, formatting, or other data to a database 108b for the single property website 102. Such content may include a description of the property, photos of the property, video tours of the property, maps of the property, information about the surrounding area (e.g., information about the community, area demographics, schools, local businesses, etc.), etc. The website generator module 108 may include a plurality of sub-modules 108a, 108b, 108c, and 108d that include computer-executable instructions to process 108a the plurality of data feeds 106 to extract data and other content 102a for display on the single property website 102, store content 108b in a database, format 108c the database data into the single property website 102, send and receive emails 108d to/from brokers, buyers, sellers, and other users of the system 100, and other instructions to generate and update a single property website 102, maintain user interaction with the system 100, etc.

Other systems 110 that are external to the website generator module 108 may provide services to the website generator module 118 or other modules of the system 100. Generally speaking, each external system 110 includes an API that permits the website generator module 108 to access and use functions and modules of the external system 110 to generate and maintain a single property website 102. In some embodiments, the external systems 110 include a domain name registration system 110a that may execute one or more commands initiated from the website generator module 108 to confirm and register a uniform resource locator (URL) or domain name 102b for the single property website 102. Other external systems 110 may include a Domain Name Service (DNS) manager 110b that organizes and maintains records for the single property website domains and search engine optimization (SEO) and social media tracking system 110c. The SEO system 110c may receive data from the website generator module 118 or other components of the system 100 and return data indicating the visibility of the single property website 102 in search engines via various search results, within social media outlets (e.g., Facebook®, Twitter®, etc.), or other data indicating an amount of Internet popularity and exposure for the single property website 102. The SEO system 110c may also alert various search engines (e.g., Google®, Bing®, Ask®, etc.) that a single property website 102 has been launched by calling an API of the search engine. The SEO system 110c may include the Raven® or other suite of SEO and social media tracking tools.

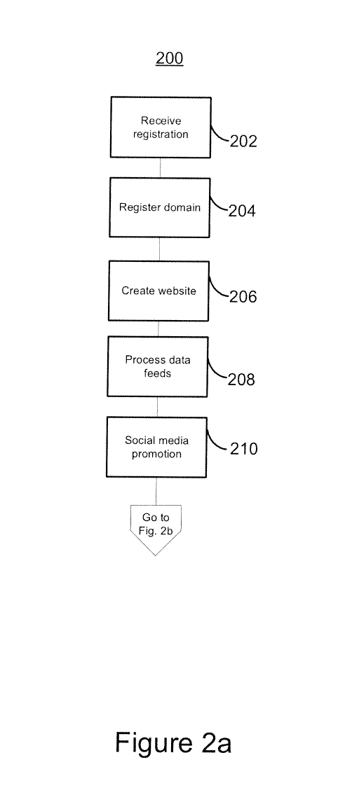

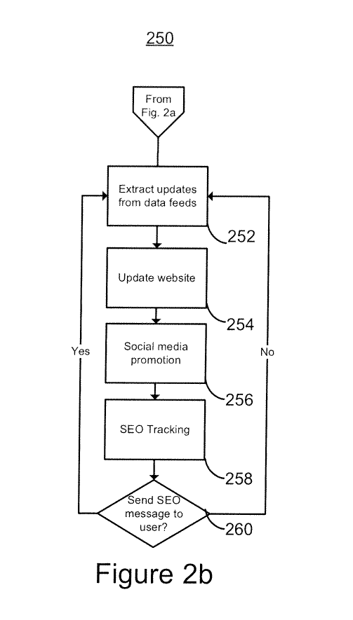

FIG. 2a illustrates an exemplary block diagram of a method 200 for generating a single property website 102 corresponding to an MLS listing. In some embodiments, the method 200 uses the system 100 and its various components as described herein. The method 200 may include one or more blocks, modules, functions, or routines in the form of computer-executable instructions that are stored in a tangible computer-readable medium and executed using a processor of a computing device (e.g., a computing device of a system 100 for generating and maintaining a single property website 102 corresponding to a property listing 104, as described herein). The method 200 may be included as part of any modules of a computing environment for a system 100 for generating and maintaining a single property website 102 corresponding to a property listing 104. For example, the method 200 may be part of a website generator module 108 executing within a computing device of the system 100. FIG. 2b illustrates an exemplary block diagram of a method 250 for maintaining, updating, editing, and/or promoting via other websites a single property website 102. The method 250 may include one or more blocks, modules, functions or routines in the form of computer-executable instructions that are stored in a tangible computer-readable medium and executed using a processor of a computing device (e.g., a computing device of a system 100 for generating and maintaining a single property website 102 corresponding to a property listing 104, as described herein). The method 200 may be included as part of any modules of a computing environment for a system 100 for maintaining, updating, editing, and/or promoting via other websites a single property website 102 corresponding to a property listing 104. FIGS. 2a and 2b are described with reference to other Figures for ease of explanation, but the method 200 can of course be utilized with other objects, APIs, user interfaces. etc., and implemented on the computing system 400 described below.

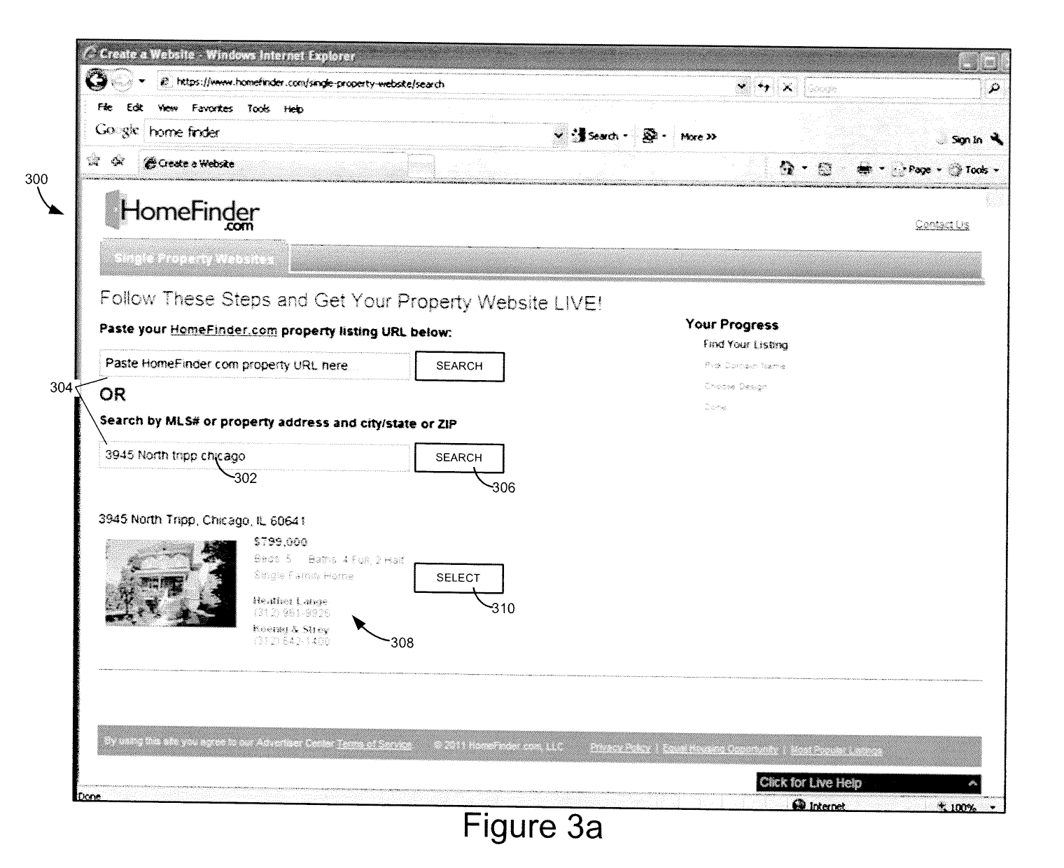

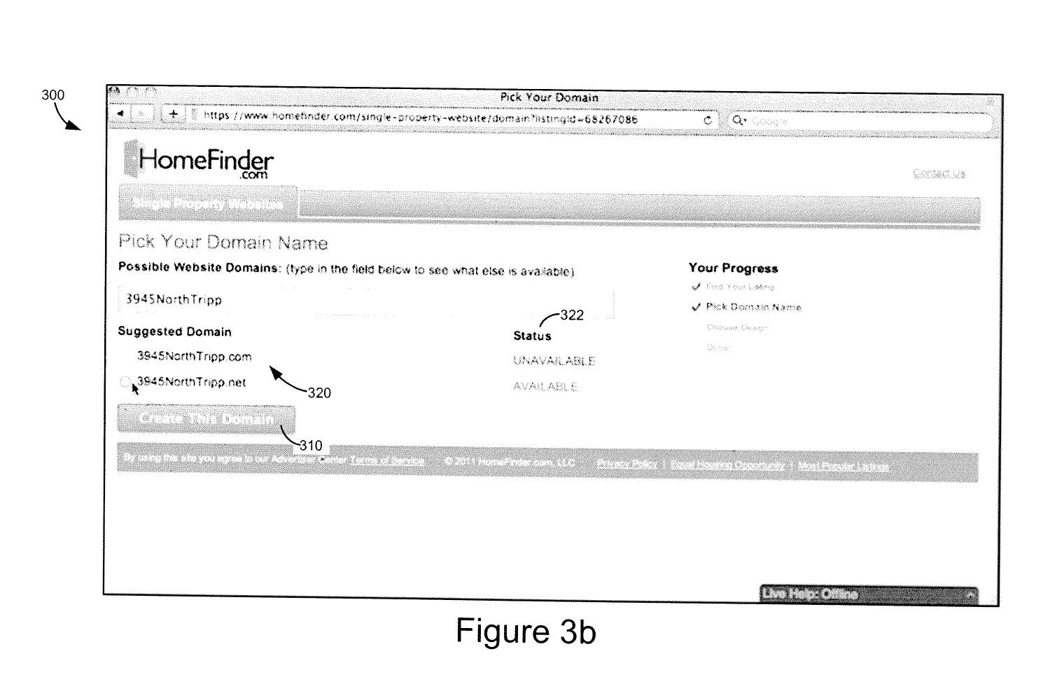

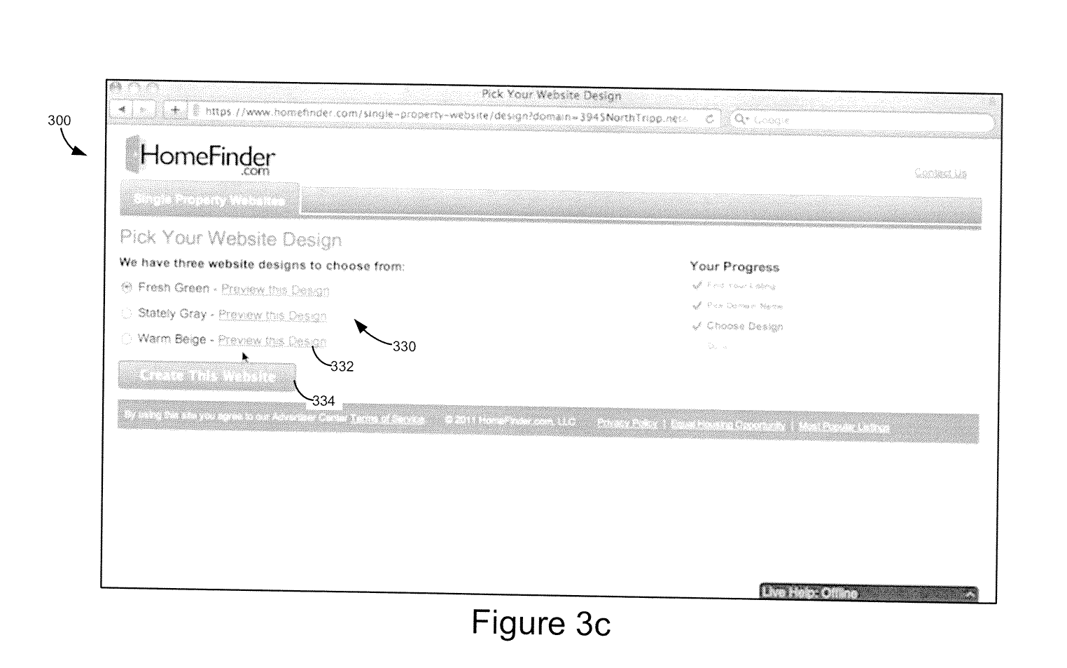

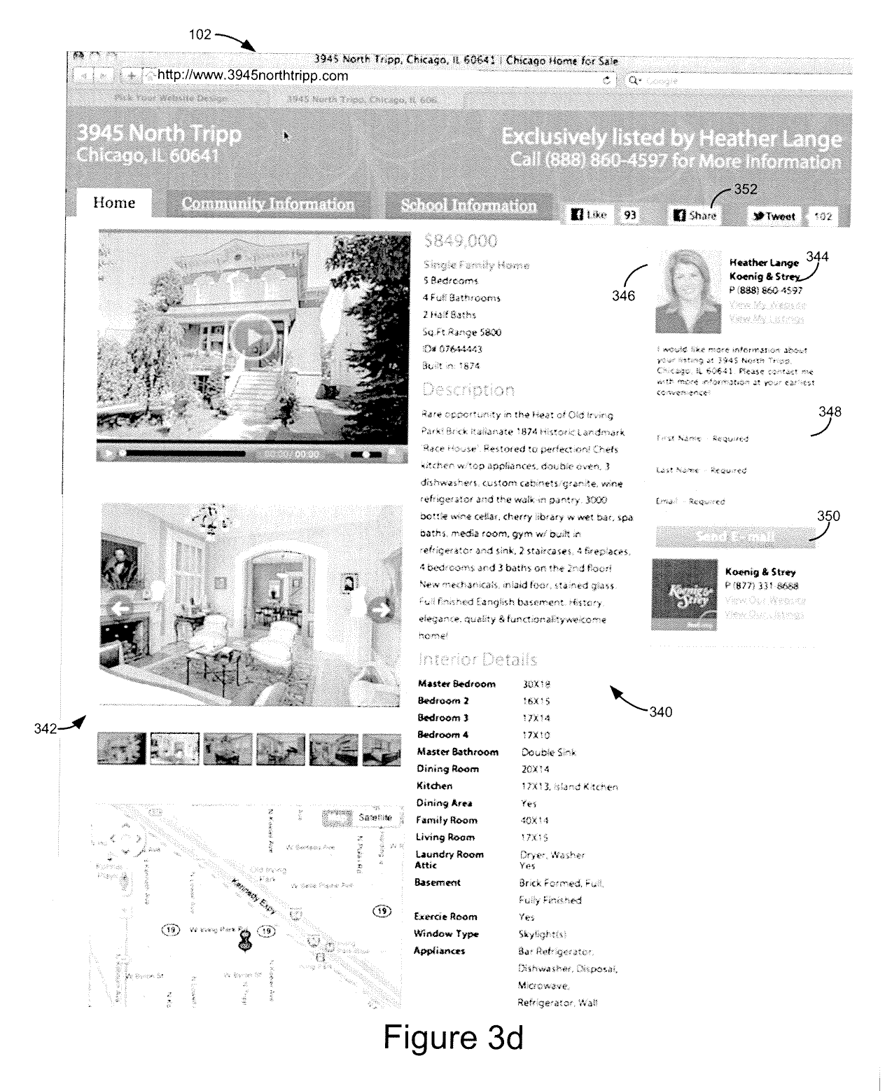

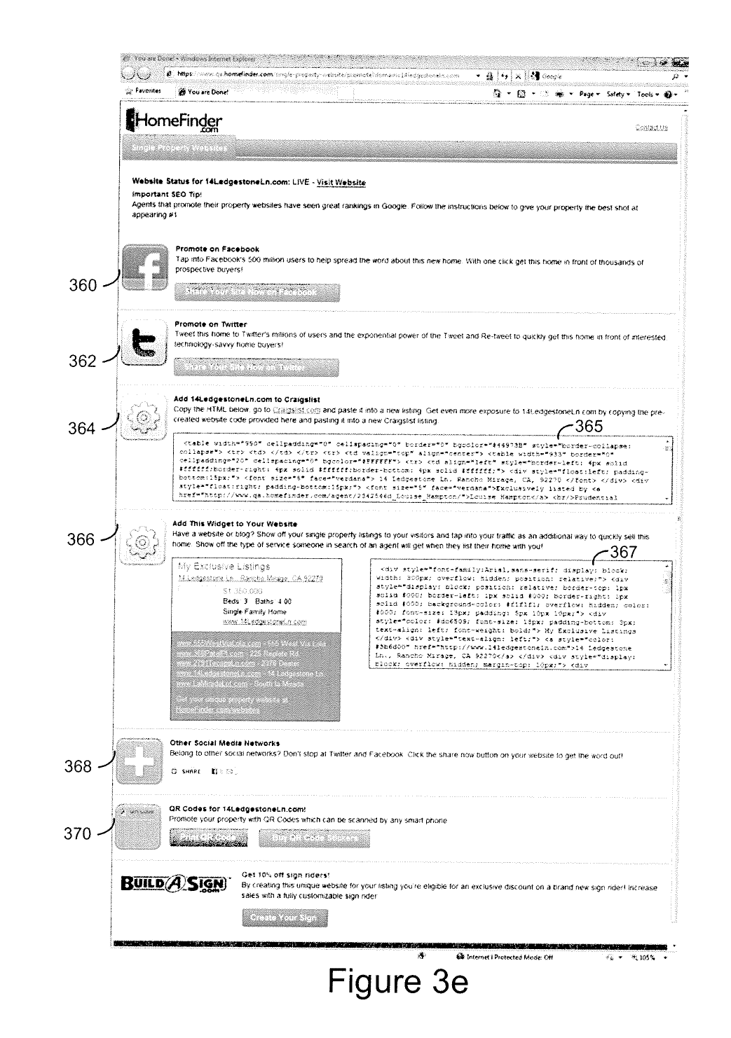

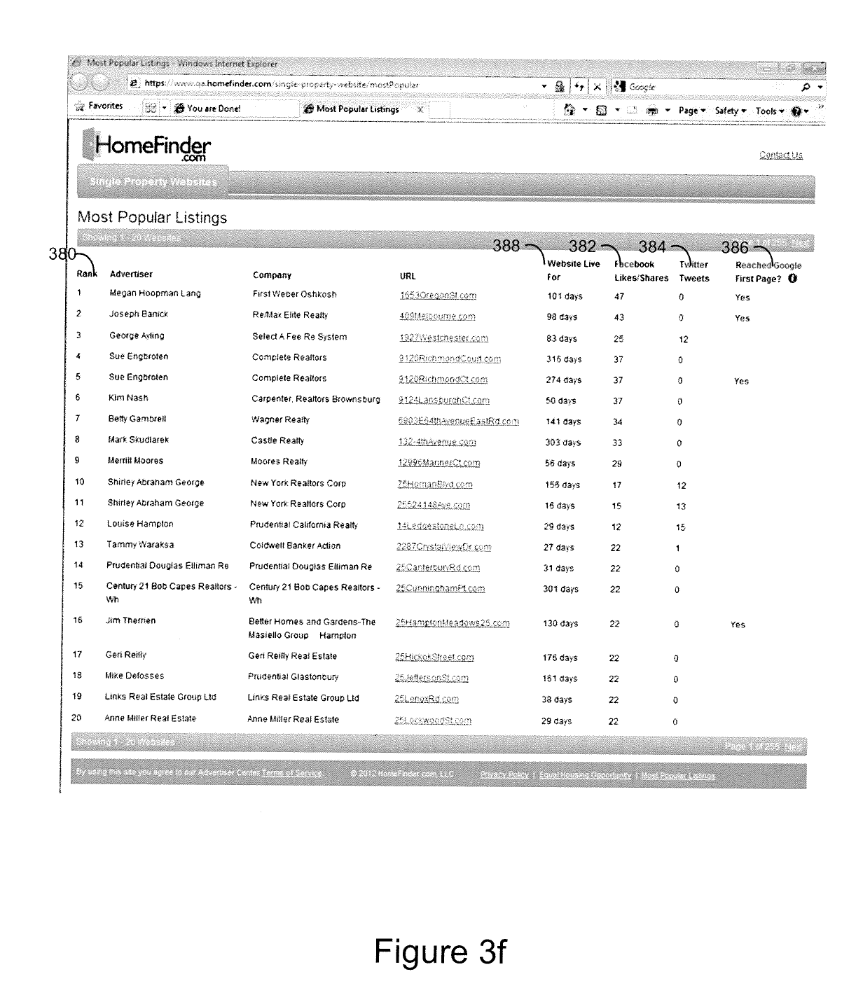

At block 202, the method 200 may receive registration data. With reference to FIGS. 3a, 3b, and 3c, a user interface 300 to the system 100 may request information from a user to identify an MLS listing or other data to identify a property for sale. In some embodiments, the user interface 300 includes a web interface that executes one or more instructions of block 202 to render the interface 300 within an internet browser of a computing device. As illustrated by FIG. 3a, block 202 may receive listing information 302 within a text box 304 of the interface 300. The information 302 may include a URL to particular listing data, an MLS number, or a property address. Once block 202 receives the information, and upon a user's selection of the button 306, the system 100 may receive a web request that causes the system 100 to find an MLS entry or other data for the property described by the listing information 302. If the web request initiated by the button 306 returns listing data 308, then the system 100 may use the data 308 to create a single property website 102. In some embodiments, block 202 may initiate a further web request via button 310 to select the data 308 and further create the single property website 102.

With reference to FIG. 3b, the further web request may cause another web page to be displayed as the user interface 300. After finding and selecting the listing data 308, block 202 may include further instructions to receive a domain name selection corresponding to the listing data 308. In some embodiments, block 202 may use an external system 110 to select a domain name. For example, block 202 may include instructions to query the whois servers or may include instructions to direct the domain name registration system 110a to query the whois servers to determine the availability of one or more domain names 320 that include a portion of the listing data 308. The domain name system 110a may then return an availability status 322 of the queries to the system 100 for display within the user interface 300. Block 202 may include instructions to receive a selection of one of the available, suggested domain names 320, and also receive the selection of another button 310 to continue the website generation method 200. With reference to FIG. 3c, continuing the method may cause the system 100 to display another web page within the user interface 300. Block 202 may include further instructions to receive a layout selection 330 for the single property website 102. Block 202 may also include instructions to cause a preview 332 for a received selected layout for the single property website 102. Block 202 may then receive a selection of one of the layout choices 330 and may also initiate a further web request in response to selection of the button 334. Thus, block 202 may facilitate receiving and sending various registration data to create a single property website 102. For example, block 202 may include computer-executable instructions to receive property listing identification data 302, property listing selection data 308, domain name selection data 320, and layout design data 330, to name only a few of the possible types of data block 202 may receive and send to the system 100.

At block 204, the method 200 may cause a processor to execute computer-executable instructions to register the selected domain name with the domain name system 110a. The method may also update the DNS records of the selected domain name using the DNS manager 110b to associate the domain name with servers that are in communication with the website database 108b.

At block 206, the method 200 may cause a processor to execute computer-executable instructions to create the single property website 102 using a plurality of data feeds corresponding to the property listing 104 and the property selected at block 202. In some embodiments, block 206 may read data from the database 108b. The database 108b may be populated by data from the feeds (e.g., data feeds 106a1, 106b1, 106c 1, 106d1, and 106e1, respectively). The data stored in the database 108b that is displayed by the single property website may be received from the MLS system 106a, a data aggregator system 106b, a real estate broker system 106c, a classified ads system 106d, or other data systems 106e.

As discussed herein, the data feeds 106a1 106b1, 106c1, 106d1, 106e1 may include content pertaining to the property listing 104. The content from each data feed 106a1, 106b1, 106c1, 106d1, 106e1 may be referred to as a group of data sets. For example, all of the content from a first MLS data feed 106a1 may comprise a first data set, all of the content from a second MLS data feed 106a1 may comprise a second data set, all of the content from a classified ads data feed 106d1 may comprise a third data set. etc. Furthermore, each data set may comprise subsets. For example, the first data set comprised of data from the first MLS data feed 106a1 may comprise a first data subset including photographs, a second data subset including a textual description of the property, a third data subset including the address of the property, a fourth data subset including the listing price of the property, etc. Additionally, a particular property may be listed in multiple data feeds (e.g., multiple MLS, classified ads systems, etc.). In such cases, the system may process the data feeds to identify listings that are duplicates to the particular property listing by identifying subsets within in each data feed that are identical. For example, a first and second MLS data feed 106a1 may both include identical third data subsets indicating that the address of the property referred to in both data feeds 106a1 is the same. Accordingly, the first and second MLS data feeds 106a1 may be referred to as “duplicate listings.” If two or more data feeds 106a1, 106b1, 106c1, 106d1, 106e1 contain identical data subsets of information, the system may select only one duplicate listing to incorporate into the single property website 102.

Alternatively, in some embodiments where two or more data feeds 106a1, 106b1, 106c1, 106d1, 106e1 contain some data subsets that are identical but other data subsets that are different, the system may extract data from each duplicate listing and merge the information into a single listing. Thus, the single listing may include the identical subset(s) as well as the different subset from each data feed 106a1, 106b1, 106c1, 106d1, 106e1. For example, a property may be listed on two MLSs that cover overlapping regions. In such an instance, the system may extract the subset(s) comprising textual information from one MLS listing and extract subset(s) comprising photos from the second MLS listing. Accordingly, the single property website 102 may display the textual information from the first MLS listing and the photographs from the second MLS listing. In other embodiments, the system 100 may select one duplicate MLS listing that includes data having an upload or edit date that is more recent than an identified duplicate listing as a source over the listing having older data. In still further embodiments, after identifying duplicate MLS listings, the system may ask the user to select which of the plurality of MLS listings should be used to create the single property website 102.

The method 200 may execute instructions to process data feeds at block 208. In some embodiments, block 208 may extract data from the data feeds 106a1, 106b1, 106c1, 106d1, 106e1 of the data source systems 106 that correspond to the property that was selected at block 202. Block 208 may execute instructions to format and store the data in the website database 108b corresponding to the single property website 102. With reference to FIG. 3d, block 208 may format and store various data as extracted from the data feeds to generate the single property website 102. For example, the single property website may include MLS data 340 such as price, general facts, a description of the property, interior details, etc. Additionally, block 208 may format and save photos and video 342 from a broker data source 106c, an aggregator 106b, or other data systems 106e.In addition to the MLS data, block 208 may format and save description and other data from a classified ads system 106d. Broker information 344 may be formatted and saved from a broker data source 106c. Block 208 may also include formatting the data to add further functions to the single property website 10252 using the extracted data. For example, the broker data 344 may be formatted into a leads generation window 346. The leads generation window may include one or more text boxes 348 for accepting a user's information and a button 350 that may be selected to initiate a web request to send the entered information to the system 100 or directly to the broker identified by the broker information 344. In some embodiments, block 208 may cause a processor to execute computer-executable instructions to group or arrange data, files, text, etc. from more than one data feed together. For example, the system may arrange the single property website 102 such that MLS data appears together with data from a mapping website. In some embodiments, extracted data may be arranged on the single property website 102 using techniques to further search engine optimization (e.g., putting keywords in the single property website's headers, footers, or metadata: optimizing hyperlinks; changing words or phrases in the listing to synonymous words or phrases; etc.).

Block 210 may cause a processor to execute computer-executable instructions to give the user the option to promote the single property website 102 using one or more social networks using social media functions 352. With reference to FIG. 3e, a social media button 352 of the single property website 102 may initiate a web request to allow a user to publicize the property using one or more social media services 110c. Publicizing using social media services 110c may include posting hyperlinks to the single property website 102 on various social media networks (e.g., Twitter®, Facebook®, etc.) and may include posting comments along with the hyperlink. The single property website 102 may include several social media functions 352. For example, such social media functions 352 could appear as a tab on the single property website 102 as in FIG. 3d or as a separate page as in FIG. 3e. Such social media functions may include a function to promote the single property website on Facebook® 360 or functions to promote the single property website 102 on Twitter® 362 or other social media outlets. Additionally, the single property website 102 may include functions that generate web page markup language scripts (e.g., HTML scripts) which the user my input to another website for additional promotion. For example, the single property website may include a function 364 that generates a first HTML script 365 to post into a listing on a classified ad site such as Craigslist®. Such a listing may include some or all of the information contained on the single property website 102 (e.g., textual descriptions, photographs, etc.) and may also include a hyperlink that, when selected, will direct a computing device to the single property website 102. Additionally or alternatively, the single property website 102 may include a function 366 that generates a second HTML script 367 that can be posted to a user's website other than the single property website 102 linking to the single property website 102. When posted to a user's website other than the single property website 102, the second HTML script 367 may cause the other website to display a “widget” in addition to linking to the single property website 102. The widget may include a subset of the information included in single property website 102 (e.g., photographs, textual descriptions, listing price, etc.). The single property website 102 may also include one or more functions 368 to promote the single property website 102 on other social media networks.

The single property website 102 may further include a function 370 which generates a barcode or other scannable code such as a quick response (QR) code that a user can render on physical media such as posters or stickers and post or distribute in the physical world. Such barcodes can be scanned by computing devices with a scanner or camera and networking capability such as a smart phone or tablet computer to direct the devices' web browser to the single property website 102. The data from the data feeds that corresponds to the single property website 102 is automatically stored in the website database 108b and associated with that single property website 102.

With reference to FIG. 2b, at block 252, the method 250 may cause a processor to execute computer-executable instructions to extract or receive the updated data from the data feeds 106a 1, 106b1, 106c1, 106d1, and 106e 1. In some embodiments, the data feeds 106a 1, 106b1, 106c1, 106d1, and 106e1 are received by the system 100 periodically. All updates to the data in the data feeds may flow to the website database 108b and, thus, the single property website 102. For example, if a broker lowers a property's price or changes a property description at an MLS data source 106a, then the single property website 102 may immediately reflect that changed price. Similarly, if a classified ad within the system 106d is changed, then the single property website 102 may immediately reflect that changed information, too. In other embodiments, the data feeds 106a 1, 106b1, 106c1, 106d1, 106e1 may include instructions alerting the system 100 that changes have been made to the data feed. The data feed could push the changed data into the system 100 or merely alert the system 100 that the extraction step of block 252 should occur immediately rather than waiting until the next periodic update iteration. At block 254, the method 200 may update the data within the website database 108b using the data extracted or received at block 252. At block 256, the method 200 may execute computer-executable instructions similar to those at block 210 to allow the use to promote the single property website 102 on one or more social networks.

At block 258, the method 200 may execute computer-executable instructions to initiate search engine optimization (SEO) and other tracking for the single property website 102 created using the method 200 of FIG. 2a. In some embodiments, block 258 includes instructions to use keywords for the registered domain to track statistics for the single property website 102. The statistics may relate to views of the website, various links to the website, references to the website in social media outlets (such as the number of “tweets”, “likes”, shares, etc.), and other measures of a level of exposure the created single property website 102 has had across the World Wide Web (WWW). For example, the method 200 may use a first line of the property address as one keyword (e.g., “3945 North Tripp”) and a full address as a second keyword (e.g., “3945 North Tripp Chicago Ill. 60641) to determine the level of WWW exposure of the website 102. Block 258 may also receive statistics or other information from an external SEO system 110c indicating a popularity or effectiveness of the single property website 102. In some embodiments, block 258 includes instructions to receive ranking data from an SEO system 110c and block 260 includes instructions to analyze the received data and forward analysis results to a user via the e-mail services module 108d. The SEO data may be sent to the user periodically (e.g., daily, weekly, monthly) or after a triggering event (e.g., when the single property website 102 gets a certain number of “likes” or when the single property website 102 is listed on the first page of search results).

Referring now to FIG. 3f, the single property website's SEO and other tracking functions may also include a function that ranks listings by popularity based on various factors. The ranking function may track indicators of popularity such as the total number of times a single property website 102 has been “liked” or shared on a social media network such as Facebook® 382, the total number of times a single property website 102 has been tweeted (i.e., posted to Twitter®) 384, and whether the single property website 102 appears on the first page of search engine results 386. For example, a first single property website 102 may have been shared one hundred times while a second single property website 102 has been shared two hundred times. Accordingly, the second single property website 102 might be ranked higher than the first single property website 102. In addition, the ranking function may also track the amount of time each single property website 102 has been live 288, which may give the ranking function the ability to track the rate of change of the indicators of popularity described herein in addition to tracking the total number of social media factors. This rate of change may be represented as a function of the increasing indicators of popularity with respect to time. For example, if a first single property website 102 is being tweeted once per day on average and a second single property website 102 is being tweeted once per week, the first single property website 102 may be ranked higher than the second single property website because the first single property website's 102 rate of change is greater. The results of the ranking function may be displayed as a leaderboard website. The leaderboard website may display the rank of the website 380, advertiser, the company for which the advertiser works, the URL of the single property website 102, the indicators of popularity (e.g., the number of likes and shares 382, number of tweets 384, and/or whether the single property website appears on the first page of search engine results 386), and how long the single property website has been live 388.

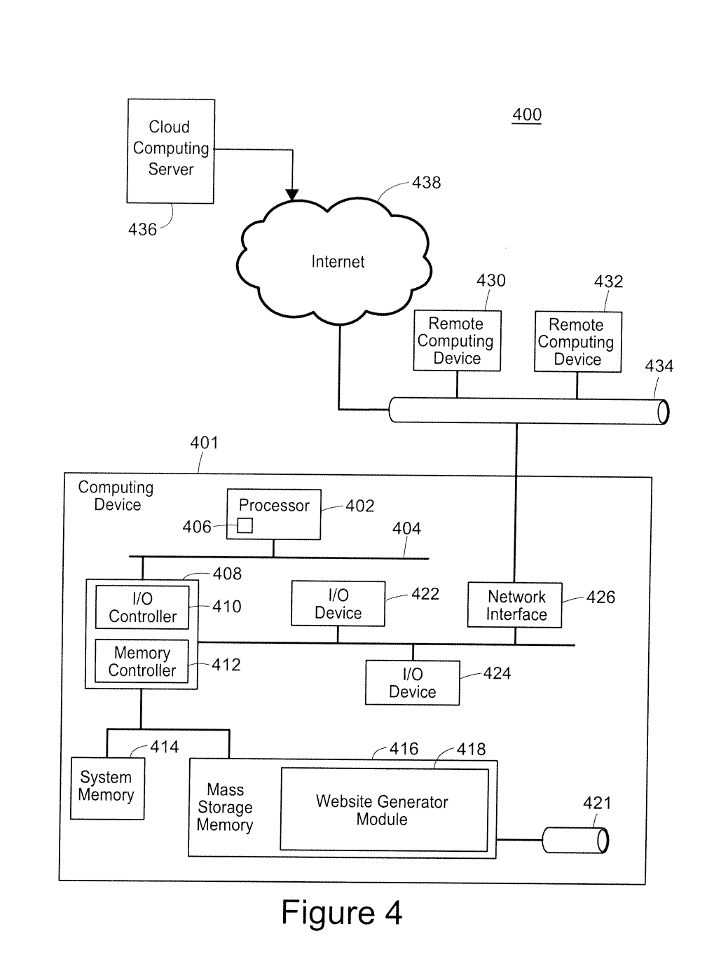

FIG. 4 is a high-level block diagram of an example computing environment for a single property website generator system 400 having a computing device 401 that may be used to implement the method 200 for generating the single property website 102 from a plurality of real-time data feeds 106. The computing device 401 may include a personal computer, thin client, or other known type of computing device. As will be recognized by one skilled in the art, in light of the disclosure and teachings herein, other types of computing devices can be used that have different architectures. Processor systems similar or identical to the example single property website generator system 400 may be used to implement and execute the example website generator module 108 including the feed processing 108a, website database 108b, data formatting 108c, and email services 108d modules of FIG. 1, the exemplary block diagram of FIGS. 2a and 2b, and the user interface 300 and web pages of FIGS. 3a, 3b, 3c, 3d, 3e, 3f. Although the example single property website generator system 400 is described below as including a plurality of peripherals, interfaces, chips, memories, etc., one or more of those elements may be omitted from other example processor systems used to implement and execute the example single property website generator system 400. Also, other components may be added.

As shown in FIG. 4, the system 400 includes a processor 402 that is coupled to an interconnection bus 404. The processor 402 includes a register set or register space 406, which is depicted in FIG. 4 as being entirely on-chip, but which could alternatively be located entirely or partially off-chip and directly coupled to the processor 402 via dedicated electrical connections and/or via the interconnection bus 404. The processor 402 may be any suitable processor, processing unit, or microprocessor. Although not shown in FIG. 4, the system 400 may be a multi-processor system and, thus, may include one or more additional processors that are identical or similar to the processor 400 and that are communicatively coupled to the interconnection bus 404.

The processor 402 of FIG. 4 is coupled to a chipset 408, which includes a memory controller 410 and a peripheral input/output (I/O) controller 412. As is well known, a chipset typically provides I/O and memory management functions as well as a plurality of general purpose and/or special purpose registers, timers, etc. that are accessible or used by one or more processors coupled to the chipset 408. The memory controller 410 performs functions that enable the processor 402 (or processors if there are multiple processors) to access a system memory 414 and a mass storage memory 416.

The system memory 414 may include any desired type of volatile and/or non-volatile memory such as, for example, static random access memory (SRAM), dynamic random access memory (DRAM), flash memory, read-only memory (ROM), etc. The mass storage memory 416 may include any desired type of mass storage device. For example, if the single property website generator system 400 is used to implement a website generator module 418, the mass storage memory 416 may include a hard disk drive, an optical drive, a tape storage device, a solid-state memory (e.g., a flash memory, a RAM memory, etc.), a magnetic memory (e.g., a hard drive), or any other memory suitable for mass storage. As used herein, the terms module, function, operation, procedure, routine, step, and method refer to computer program logic or computer executable instructions that provide the specified functionality to the computing device. Thus, a module, function, operation, procedure, routine, step, and method can be implemented in hardware, firmware, and/or software. In one embodiment, program modules and routines e.g., web page generator module 418 and various APIs) are stored in mass storage memory 416, loaded into system memory 414, and executed by a processor 402 or can be provided from computer program products that are stored in tangible computer-readable storage mediums (e.g., RAM, hard disk, optical/magnetic media, etc.). Mass storage 416 may also include a database 421 storing a plurality of single property websites 102, data feeds, registration and configuration data, etc., and a database interface module through which the website generator module 418 may access data to generate, update, and maintain the single property websites 102.

The peripheral I/O controller 410 performs functions that enable the processor 402 to communicate with peripheral input/output (I/O) devices 422 and 424 and a network interface 426 via a peripheral I/O bus 428. The I/O devices 422 and 424 may be any desired type of I/O device such as, for example, a keyboard, a display (e.g., a liquid crystal display (LCD), a cathode ray tube (CRT) display, etc.), a navigation device (e.g., a mouse, a trackball, a capacitive touch pad, a joystick, etc.), etc. The I/O devices 422 and 424 may be used with the website generator module 418 to receive registration information, data feeds, and other information as described in relation to FIGS. 2a and 2b, above. The network interface 428 may be, for example, an Ethernet device, an asynchronous transfer mode (ATM) device, an 802.11 wireless interface device, a DSL modem, a cable modern, a cellular modem, etc., that enables the single property website generator system 400 to communicate with another computer system (e.g., the data source systems 106, the external systems 110, etc.) having at least the elements described in relation to the single property website generator system 400.

While the memory controller 412 and the I/O controller 410 are depicted in FIG. 4 as separate functional blocks within the chipset 408, the functions performed by these blocks may be integrated within a single integrated circuit or may be implemented using two or more separate integrated circuits.

The single property website generator system 400 may also implement the website generator module 418 on remote computing devices 430 and 432. The remote computing devices 430 and 432 may communicate with the computing device 401 over an Ethernet link 434. For example, the computing device 401 may receive data feeds 106a1, 106b1, 106c1, 106d1, and 106e1, domain name registration and other domain name data, and SEO/Social Media data from a remote computing device 430, 432. In other embodiments, the website generator module 418 may be retrieved by the computing device 401 from a cloud computing server 436 via the Internet 438. When using the cloud computing server 436, the website generator module 418 may be programmatically linked with the computing device 401. The website generator module 418 may be a Java® applet executing within a Java® Virtual Machine (JVM) environment resident in the computing device 401 or the remote computing devices 430, 432. The website generator module 418 may also be “plug-ins” adapted to execute in a web-browser located on the computing devices 401, 430, and 432.

Using the systems and procedures described above, a user can create a single property website 102 that uses real-time data feeds 106a1, 106b1, 106c1, 106d1, and 106e1 from a plurality of data source systems 106a, 106b, 106c, 106d, and 106e. The single property website 102 may be created by the system 100, 400 while receiving with minimal input from the user. The single property website 102 may also provide a dynamic experience for a potential buyer by presenting real-time information about the property such as price fluctuations, market conditions, mortgage rates and calculations, comparables, evaluations, etc.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

For example, the system 100, 400 may include but is not limited to any combination of a LAN, a MAN, a WAN, a mobile, a wired or wireless network, a private network, or a virtual private network. Moreover, while only two remote computing devices 430 and 432 are illustrated in FIG. 4 to simplify and clarify the description, it is understood that any number of client computers are supported and can be in communication within the system 400.

Additionally, certain embodiments are described herein as including logic or a number of blocks, components, modules, or mechanisms. Blocks may constitute either software blocks (e.g., code embodied on a machine-readable medium or in a transmission signal, wherein the code is executed by a processor) or hardware blocks. A hardware block is a tangible unit capable of performing certain operations and may be configured or arranged in a certain manner. In example embodiments, one or more computer systems (e.g., a standalone, client or server computer system) or one or more hardware blocks of a computer system (e.g., a processor or a group of processors) may be configured by software (e.g., an application or application portion as a hardware block that operates to perform certain operations as described herein.

In various embodiments, a hardware block may be implemented mechanically or electronically. For example, a hardware block may comprise dedicated circuitry or logic that is permanently configured (e.g., as a special-purpose processor, such as a field programmable gate array (FPGA) or an application-specific integrated circuit (ASIC) to perform certain operations. A hardware block may also comprise programmable logic or circuitry (e.g., as encompassed within a general-purpose processor or other programmable processor) that is temporarily configured by software to perform certain operations. It will be appreciated that the decision to implement a hardware block mechanically, in dedicated and permanently configured circuitry, or in temporarily configured circuitry (e.g., configured by software) may be driven by cost and time considerations.

Accordingly, the term “hardware block” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented block” refers to a hardware block. Considering embodiments in which hardware blocks are temporarily configured (e.g., programmed), each of the hardware blocks need not be configured or instantiated at any one instance in time. For example, where the hardware blocks comprise a general-purpose processor configured using software, the general-purpose processor may be configured as respective different hardware blocks at different times. Software may accordingly configure a processor, for example, to constitute a particular hardware block at one instance of time and to constitute a different hardware block at a different instance of time.

Hardware blocks can provide information to, and receive information from, other hardware blocks. Accordingly, the described hardware blocks may be regarded as being communicatively coupled. Where multiple of such hardware blocks exist contemporaneously, communications may be achieved through signal transmission (e.g., over appropriate circuits and buses) that connect the hardware blocks. In embodiments in which multiple hardware blocks are configured or instantiated at different times, communications between such hardware blocks may be achieved, for example, through the storage and retrieval of information in memory structures to which the multiple hardware blocks have access. For example, one hardware module may perform an operation and store the output of that operation in a memory device to which it is communicatively coupled. A further hardware module may then, at a later time, access the memory device to retrieve and process the stored output. Hardware blocks may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules or blocks that operate to perform one or more operations or functions. The blocks referred to herein may, in some example embodiments, comprise processor-implemented blocks.

Similarly, the blocks, methods or routines described herein may be at least partially processor-implemented. For example, at least some of the operations of a method may be performed by one or processors or processor-implemented hardware blocks. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs).)

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “some embodiments” or “an embodiment” means that a particular element, feature, structure, or characteristic described in connection with the embodiment is included in at least one embodiment. The appearances of the phrase “in some embodiments” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover anon-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description should be read to include one or at least one and the singular also includes the plural unless it is obvious that it is meant otherwise.

Still further, the figures depict preferred embodiments of a single property website generation system for purposes of illustration only. One skilled in the art will readily recognize from the following discussion that alternative embodiments of the structures and methods illustrated herein may be employed without departing from the principles described herein

Upon reading this disclosure, those of skill in the art will appreciate still additional alternative structural and functional designs for a system and a process for identifying terminal road segments through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed:

1. A computer-implemented method for generating a single proper website within a computer system via a network connection, the method comprising:
aggregating a plurality of electronic data feeds, the plurality of data feeds including information related to one or more listings for a piece of real estate;
extracting first data for the piece of real estate from at least one electronic data feed;
using a processor of the computer system to arrange the extracted first data into a single property website for the piece of real estate;
extracting second data for the piece of real estate from at least one electronic data feed;
comparing the extracted first data to the extracted second data; and
updating the single property website based on the comparison of the extracted first data to the extracted second data.

2. The method of claim 1, further comprising adding a link to the single property website within another website, wherein selecting the added link causes a processor of a computing device displaying the page to initiate a web request from the device to the single property website.

3. The method of claim 2, wherein adding the link includes one or more of:
generating a first set of instructions to display a description of the piece of real estate and the link within the other website;
generating a second set of instructions to display a subset of information included in the single property website and the link within the other website; or
generating a printable bar code, wherein scanning the bar code with a computing device initiates a web request from the device to the single property website.

4. The method of claim 1, wherein the electronic data feeds include one or more of a plurality of MLS data feeds, a classified ad data feed, or a for sale by owner data feed.

5. The method of claim 4, wherein:
a plurality of the electronic data feeds include one or more identical subsets of information related to the one or more listings for the piece of real estate, and
using a processor to arrange the data extracted from the data feeds into a single property website includes combining the information from the plurality of data feeds.

6. The method of claim 4, wherein a plurality of the electronic data feeds include one or more identical subsets of information related to the listings, and using a processor to arrange the data extracted from the data feeds into a single property website includes selecting information from only one of the data feeds including identical subsets of information.

7. The method of claim 1, further comprising extracting the first data before the second data.

8. The method of claim 1, wherein the plurality of electronic data feeds includes data associated with one or more of average property values in the area, average weather in the area, local school districts, demographic information, or maps of the area.

9. The method of claim 1, further comprising:
electronically receiving visibility data for the single property website, the visibility data including an indication of popularity for the single property website;
generating a website using the visibility data; and
ranking the single property website relative to other single property websites based on the indication of popularity.

10. The method of claim 9, wherein ranking the single property website relative to other single property websites based on the indication of popularity includes ranking all single property websites based on a total number of popularity indications or ranking the single property websites based on a rate of change function, wherein the rate of change function represents a rate at which the indications of popularity associated with each single property website increase with respect to time.

11. A computer system for generating a single property website via a network connection, the system comprising:
a memory storing instructions;
a processor for executing the stored instructions to cause the computer system to:
aggregate a plurality of electronic data feeds, the plurality of data feeds including information related to one or more listings for a piece of real estate;
extract first data for the piece of real estate from at least one electronic data feed;
arrange the extracted first data into a single property website for the piece of real estate;
extract second data for the piece of real estate from at least one electronic data feed:
compare the extracted first data to the extracted second data; and
update the single property website based on the comparison of the extracted first data to the extracted second data;
wherein the system extracts the first data before the second data.

12. The system of claim 11, wherein executing the stored instructions further causes the computer system to add a hyperlink to a page of another website, wherein selecting the added hyperlink causes a processor of a computing device displaying the page to initiate a web request from the computing device to a server hosting the single property website via the network connection.

13. The system of claim 12, wherein adding the hyperlink to the page of another website includes one or more of:
causing a processor of the computer system to generate a first set of computer readable instructions that cause a server hosting a classified ad website to host a textual description for the single property website and the hyperlink on the classified ad website;
causing a processor of the computer system to generate a second set of computer readable instructions that cause the server to display a subset of information included in the single property website and the hyperlink; or
causing a processor of the computer system to generate a printable bar code, wherein scanning the bar code with a computing device initiates a web request from the device to the single property website.

14. The system of claim 11, wherein the electronic data feeds include one or more of a plurality of MLS data feeds, a classified ad data feed, or a for sale by owner data feed.

15. The system of claim 14, wherein the electronic data feeds include one or more identical subsets of information related to the one or more listings for the piece of real estate, and executing the stored instructions causes the computer system to arrange the data extracted from the data feeds into the single property website by combining the information from the data feeds.

16. The system of claim 14, wherein the electronic data feeds include one or more identical subsets of information related to the listings for the piece of real estate, and executing the stored instructions causes the computer system to arrange the data extracted from the data feeds into the single property website by selecting information from only one of the data feeds including identical subsets of information.

17. The system of claim 11, wherein the electronic data feeds include data associated with one or more of average property values in the area, average weather in the area, local school districts, demographic information, or maps of the area.

18. The system of claim 11, wherein executing the stored instructions further causes the computer system to:
electronically receive visibility data for the single property website, the visibility data including an indication of popularity for the single property website;
generate a website using the visibility data, wherein the website ranks the single property website relative to other single property websites based on the indication of popularity.

19. A computer-implemented method for generating a single property website within a computer system via a network connection, the method comprising:
aggregating a plurality of electronic data feeds, the plurality of data feeds including information related to one or more listings for a piece of real estate;
extracting first da for the piece of a estate from the aggregated electronic data feeds; and
arranging, with a processor of the computer system,the extracted data into a single property website for he piece of real estate.

20. A tangible computer-readable medium storing instructions that when executed by a processor of a computer system cause the computer system to:
aggregate a plurality of electronic data feeds, the plurality of data feeds including information related to one or more listings for a piece of real estate;
extract first data for the piece of real estate from the aggregated data feeds;
arrange the extracted first data into a single property website for the piece of real estate;
extract second data for the piece of real estate from the aggregated data feeds;
compare the extracted first data to the extracted second data; and
update the single property website based on the comparison of the extracted first data to the extracted second data.

21. The tangible computer-readable medium of claim 20, further comprising instructions to add a hyperlink to a page of another website, wherein selecting the added hyperlink causes a processor of a computing device displaying the page to initiate a web request from the computing device to a server hosting the single property website via the network connection.

22. The tangible computer-readable medium of claim 21, wherein the instructions to add the hyperlink include one or more instructions to:
post the hyperlink to the single property website on a social network website;
generate a first set of instructions to cause a server hosting the classified ad website to host a textual description for the single property website and the hyperlink on the classified ad website;
generate a second set of instructions to cause the server to display a subset of information included in the single property website and the hyperlink; or
generate a printable bar code, wherein scanning the bar code with a computing device initiates a web request from the device to the single property website.

23. The tangible computer-readable medium of claim 20, wherein the electronic data feeds include one or more of a plurality of MLS data feeds, a classified ad data feed, or a for sale by owner data feed.

24. The tangible computer-readable medium of claim 23, wherein the electronic data feeds include one or more identical subsets of information related to the one or more listings for a piece of real estate, and arranging the data extracted from the data feeds into the single property website includes combining the information from the data feeds.

25. The tangible computer-readable medium of claim 23, wherein the electronic data feeds include one or more identical subsets of information related to the one or more listings for a piece of real estate, and arranging the data extracted from the data feeds into the single property website includes selecting information from only one of the data feeds including identical subsets of information.

26. The tangible computer-readable medium of claim 20, further comprising instructions to extract the first data before the second data.

27. The tangible computer-readable medium of claim 20, wherein the plurality of electronic data feeds includes data associated with one or more of average property values in the area, average weather in the area, local school districts, demographic information, or maps of the area.

28. The tangible computer-readable medium of claim 20, further comprising instructions that when executed by a processor of a computer system cause the computer system to:
electronically receive visibility data for the single property website, the visibility data including an indication of popularity for the single property website;
generate a website using the visibility data; and
ranking the single property website relative to other single property websites based on the indication of popularity.

29. The tangible computer-readable medium of claim 28, wherein ranking the single property website relative to other single property websites based on the indication of popularity includes ranking all single property websites based on a total number of popularity indications, or ranking the single property websites based on a rate of change function, wherein the rate of change function represents the rate at which the indications of popularity associated with each single property website increase with respect to time.

30. The method of claim 20, further comprising:
extracting second data for the piece of real estate from at least one electronic data feed:
comparing the extracted first data to the extracted second data; and
updating the single property website based on the comparison of the extracted first data to the extracted second data.
